(19) United States
(12) Patent Application Publication
(10) Pub. No.: US 2025/0291236 A1
(43) Pub. Date: Sep. 18, 2025

(54) OPTICAL APPARATUS, ACCESSORY, ACCESSORY ATTACHMENT METHOD, AND ACCESSORY DETACHMENT METHOD

(71) Applicant: CANON KABUSHIKI KAISHA, Tokyo (JP)

(72) Inventor: MASAYASU SHIGEMATSU, Tokyo (JP)

(21) Appl. No.: 19/014,607

(22) Filed: Jan. 9, 2025

(30) Foreign Application Priority Data
Mar. 12, 2024 (JP) 2024-038146

(51) Int. Cl. G03B 17/14; G02B 25/00; G03B 17/56

(52) U.S. Cl. CPC G03B 17/14; G02B 25/001; G03B 17/565

(57) ABSTRACT

An optical apparatus is attachable to and detachable from an accessory. The optical apparatus includes a non-elastic member with an eyepiece frame, and an eyecup fixed to the eyepiece frame and including an elastic member. The elastic member includes a first fixing member configured to fix the accessory and provided to at least three outer circumference side surfaces. The eyepiece frame includes a second fixing member configured to fix the accessory and provided to an area that does not face the at least three outer circumference side surfaces of outer circumference side surfaces. The first fixing member and the second fixing member fix the accessory in a case where the accessory is attached to the optical apparatus.

### BACKGROUND

### Technical Field

The disclosure relates to an optical apparatus, an accessory, an accessory attachment method, and an accessory detachment method.

### Description of Related Art

Optical apparatuses such as digital cameras have conventionally been known in which an eyecup is fixed to prevent light from entering through a gap between the eyepiece and the user. Japanese Patent Laid-Open No. 2001-228509 discloses a structure in which an elastically deformable eyecup accessory with a large flange portion is attached while it is stretched and held by the flange portion of the eyecup, at a maintained orientation and elastic contact.

In the structure disclosed in Japanese Patent Laid-Open No. 2001-228509, the eyecup has a shape with a flange all around, and it difficult to attach and detach the eyecup accessory because the eyecup accessory is fixed so that the entire circumference of the flange portion is held by an elastic part. In addition, because it is fixed by elastic parts, they are likely to disengage accidentally.

### SUMMARY

An optical apparatus according to one aspect of the disclosure is attachable to and detachable from an accessory. The optical apparatus includes a non-elastic member with an eyepiece frame, and an eyecup fixed to the eyepiece frame and including an elastic member. The elastic member includes a first fixing member configured to fix the accessory and provided to at least three outer circumference side surfaces. The eyepiece frame includes a second fixing member configured to fix the accessory and provided to an area that does not face the at least three outer circumference side surfaces of outer circumference side surfaces. The first fixing member and the second fixing member fix the accessory in a case where the accessory is attached to the optical apparatus.

An accessory according to another aspect of the disclosure is attachable to and detachable from an optical apparatus that includes a non-elastic member having an eyepiece frame, and an eyecup including an elastic member and fixed to the eyepiece frame. The accessory includes a first engagement member engageable with a first fixing member provided on at least three outer circumference side surfaces of the elastic member, and a second engagement member engageable with a second fixing member provided to an area that does not face the at least three outer circumference side surfaces of outer circumference side surfaces of the eyepiece frame. A method for attaching the above accessory to and detaching the above accessory from the above optical apparatus also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are external perspective views of a digital camera as an example optical apparatus according to one embodiment of the present disclosure.

FIG. 2 is an external perspective view of a rear cover.

FIGS. 3A and 3B are external perspective views of an eyecup.

FIGS. 4A and 4B illustrate a rear cover while the eyecup is fixed to it.

FIG. 5 is an external perspective view of the rear cover while the eyecup is fixed to it.

FIGS. 6A and 6B are external perspective views of an eyecup accessory.

FIGS. 7A, 7B, 7C, 7D and 7E illustrate an eyecup while the eyecup accessory is fixed to it.

FIGS. 8A and 8B explain the operation in attaching the eyecup accessory to the eyecup.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

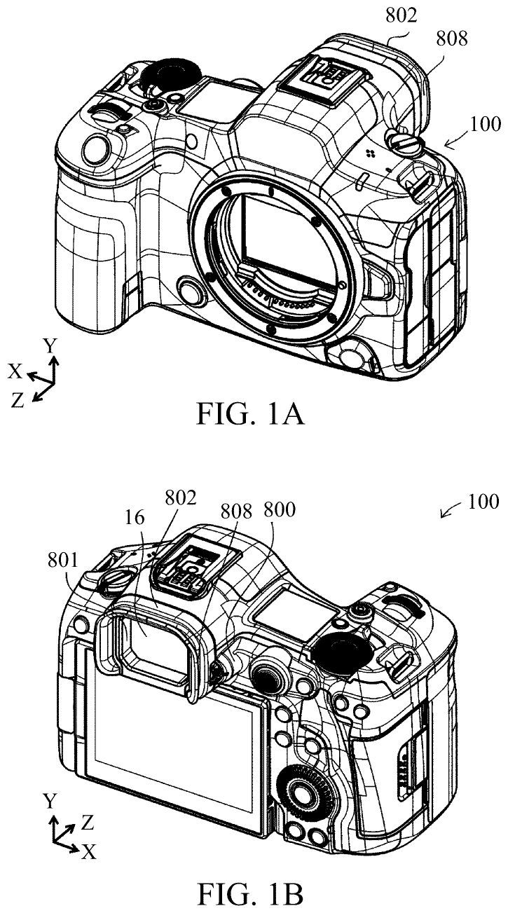

FIGS. 1A and 1B are external perspective views of a digital camera 100 as an example of an optical apparatus according to one embodiment of the present disclosure. FIG. 1A is an external perspective view of the digital camera 100 when viewed from the front, and FIG. 1B is an external perspective view of the digital camera 100 when viewed from the back. The digital camera 100 is configured such that an eyecup accessory (accessory) 700, which will be described later, such as a rain cover, a magnifier, and an angle finder, is attachable to and detachable from an eyepiece unit. The optical apparatus can include an electronic apparatus such as a mobile phone, a game machine, a tablet terminal, a personal computer, watch-type and eyeglass-type information terminals, and a head mount display. It also includes products with an eyepiece unit such as a monocular, binoculars, and a distance measurement apparatus.

The user (photographer) can view an image displayed on an internal EVF module (not illustrated) through the eyepiece unit 16 of the peer-type finder. An eyecup 802 is attached to a rear cover (non-elastic member) 800 of the digital camera 100. The part of the eyecup 802 that is to contact the user's eye vicinity is made of a soft material or the like to prevent light from entering the eyepiece viewfinder through a gap between an eyepiece frame 801 and the user.

### STRUCTURE OF EYECUP

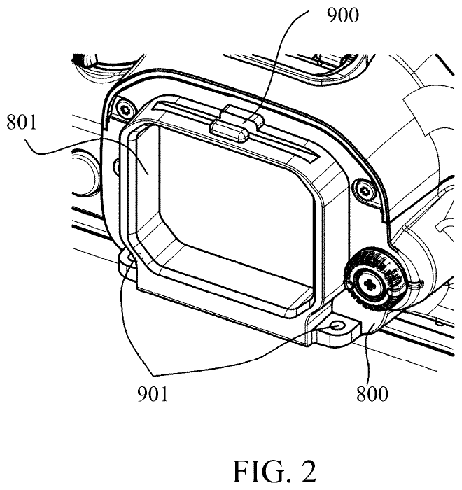

FIG. 2 is an external perspective view of the rear cover 800 viewed from the rear in a case where the eyecup 802 is detached. The eyepiece frame 801 is integrally formed with the rear cover 800. A groove portion 900 for fixing the eyecup 802 is provided on the upper side of the eyepiece frame 801. Screw holes 901 for fixing the eyecup 802 to the rear cover 800 are provided at the lower left and lower right portions of the eyepiece frame 801.

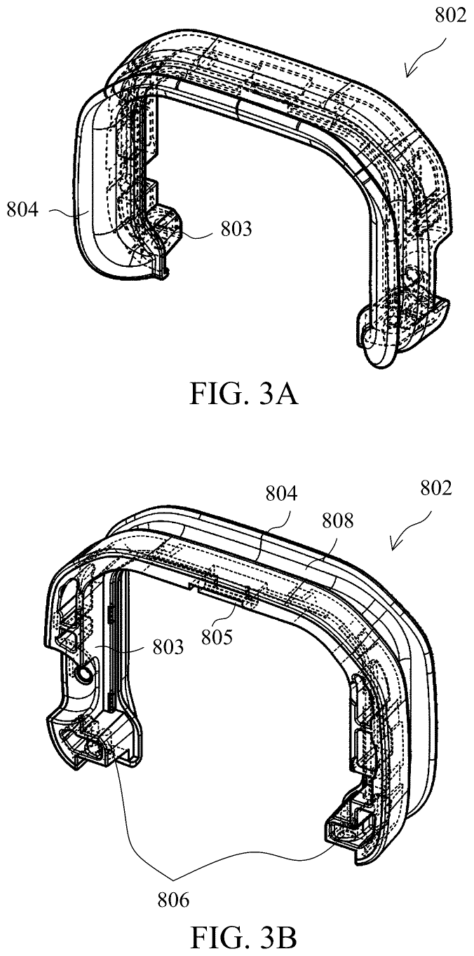

FIGS. 3A and 3B are external perspective views of the eyecup 802. FIG. 3A is an external perspective view of the eyecup 802 viewed from the rear, and FIG. 3B is an external perspective view of the eyecup 802 viewed from the front. The eyecup 802 is formed by integrally molding a molded frame 803 made of a hard, non-elastic material and a soft, elastically deformable elastic member 804. The frame 803 includes a convex portion 805 engageable with the groove portion 900 in the eyepiece frame 801, and two screw holes 806 for fixing with screws through the screw holes 901 in the rear cover 800.

In this embodiment, the elastic member 804 is formed by outserting elastomer, but it is not limited to elastomer as long as it is a soft elastic material, such as silicone rubber or other rubber materials. The hardness of the elastic member 804 may be about durometer hardness A 70 degrees in order to increase the fixing force of the eyecup accessory 700.

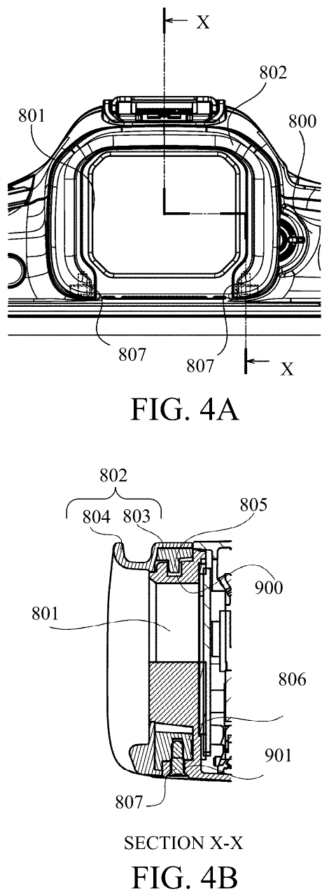

FIGS. 4A and 4B illustrate the rear cover 800 in a case where the eyecup 802 is fixed to it. FIG. 4A is a rear view of the rear cover 800 in a case where the eyecup 802 is fixed to it, and FIG. 4B is a sectional view of a line X-X in FIG. 4A. As illustrated in FIG. 4B, the groove portion 900 and a convex portion 805 are engaged, and the eyecup 802 is fixed to the rear cover 800 by screws 807.

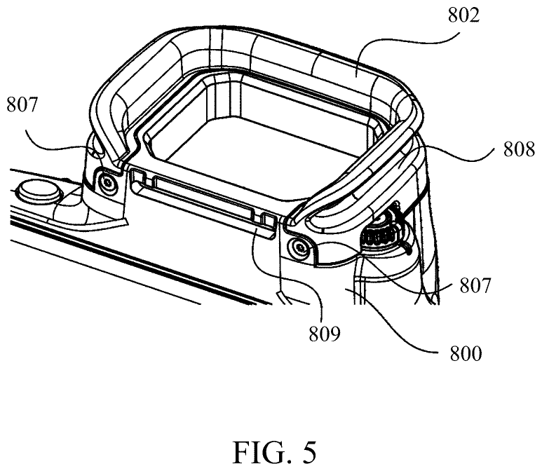

FIG. 5 is an external perspective view of the rear cover 800 in a case where the eyecup 802 is fixed to it. At least three side surfaces (outer circumference side surfaces) of the elastic member 804 have groove portions (first fixing members) 808 for fixing the eyecup accessory 700. In addition, a groove portion (second fixing member) 809 for fixing the eyecup accessory 700 is provided in an area of the side surface of the eyepiece frame 801 that does not face (is not opposite to) the at least three side surfaces of the elastic member 804 on which the groove portion 808 are provided. In this embodiment, the groove portion 808 is provided in three side surfaces at the upper, left, and right portions of the elastic member 804, and the groove portion 809 is provided on the lower side surface of the eyepiece frame 801. That is, in this embodiment, when the optical apparatus is viewed from the rear at the normal position (horizontal position), the groove portion 808 is provided in the upper, left, and right sides of the eyepiece frame 801, and the groove portion 809 are provided at the lower side of the eyepiece frame 801.

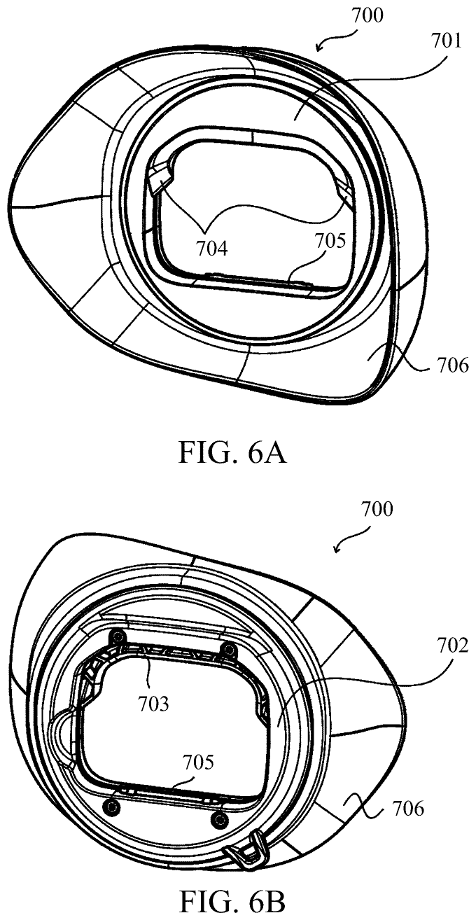

FIGS. 6A and 6B are external perspective views of the eyecup accessory 700 to be attached to the eyecup 802. FIG. 6A is an external perspective view of the eyecup accessory 700 when viewed from the rear, and FIG. 6B is an external perspective view of the eyecup accessory 700 when viewed from the rear.

The eyecup accessory 700 includes fixed members 701 and 702 which are non-elastic members. The fixed member 701 includes a convex portion (first engagement member) 703 which is formed continuously on three sides (three directions of the outer circumference) of the upper, left, and right portions engageably with the groove portion 808 provided in the side surfaces of the upper, left, and right portions of the eyecup 802. The convex portion 703 has taper portions (inclined portions or inclined surfaces) 704 at the lower (lower ends) of the left and right portions for insertion into the groove portion 808. The lower portion of the fixed member 702 includes a convex portion (second engagement member) 705 engageable with the groove portion 809 provided on the side of the lower portion of the eyepiece frame 801. An engagement amount between the convex portion 705 and the groove portion 809 is smaller than an engagement amount between the convex portion 703 and the groove portion 808. Thereby, the eyecup accessory 700 can be easily attached. In this embodiment, the engagement amount between the groove portion 808 and the convex portion 703 is about 2 mm to 4 mm, and the engagement amount between the groove portion 809 and the convex portion 705 is about 0.5 mm to 1 mm.

A flange portion 706, which is an elastic member, is rotatably attached to the outer circumference of the fixed members 701 and 702 to prevent light from entering the viewfinder through the gap between the fixed member 701 and the user. The circular outer shapes of the fixed members 701 and 702 enable the flange portion 706 to rotate by 360 degrees even if the outer shape of the eyecup 802 is not circular. Thereby, the attachment angle of the eyecup accessory 700 can be changed to match the face direction when the user peeping through the viewfinder with the right or left eye, when the user holds the digital camera 100 in a vertical position, etc.

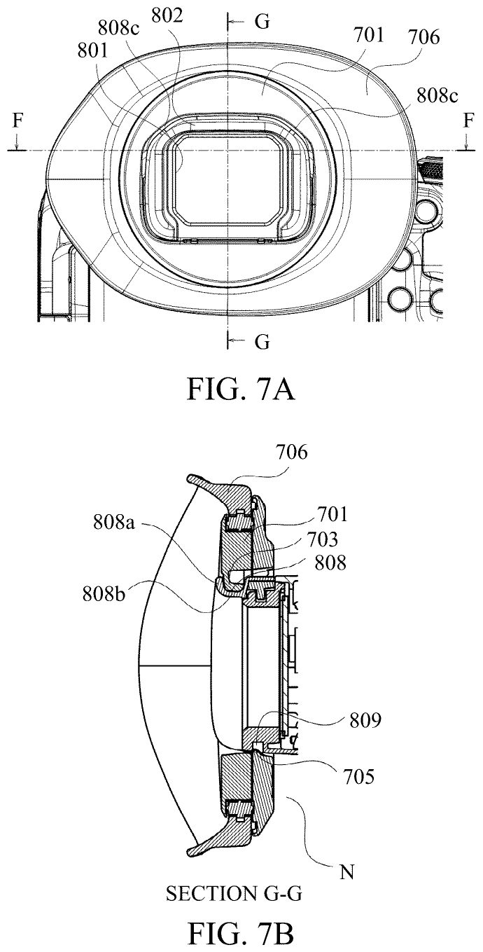

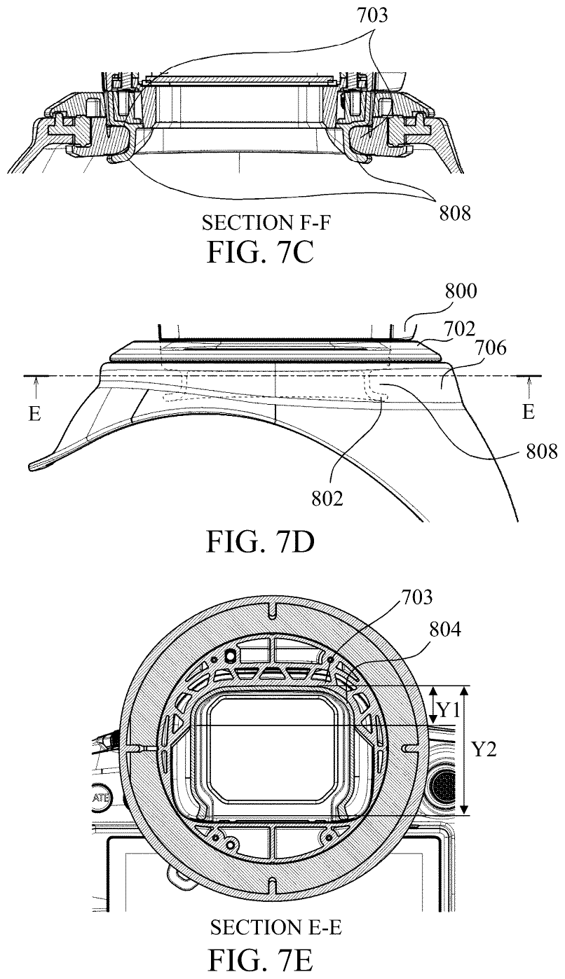

Referring now to FIGS. 7A, 7B, 7C, 7D, and 7E, a description will be given of a method for fixing the eyecup accessory 700 to the eyecup 802. FIGS. 7A, 7B, 7C, 7D, and 7E illustrate the eyecup 802 in a case where the eyecup accessory 700 is fixed to it. FIG. 7A is a rear view of the eyecup 802 in a case where the eyecup accessory 700 is fixed to it. FIG. 7B is a sectional view taken along a line G-G in FIG. 7A. FIG. 7C is a sectional view taken along a line F-F in FIG. 7A. FIG. 7D is a top view of the eyecup 802 in a case where the eyecup accessory 700 is fixed to it. FIG. 7E is a sectional view taken along a line E-E in FIG. 7D.

The convex portion 703 of the eyecup accessory 700 is engaged with the groove portion 808 provided in the elastic member 804 of the eyecup 802, and a convex portion 705 of the eyecup accessory 700 is engaged with the groove portion 809 provided in rear cover 800, which is a non-elastic member. Thereby, the eyecup accessory 700 is fixed to the eyecup 802.

As illustrated in FIG. 7E, the upper, left, and right sides of convex portion 703 are continuous, so that in a case where the eyecup accessory 700 is to be detached from the eyecup 802, a flange portion 808a of the eyecup 802 is to be elastically deformed simultaneously in three directions perpendicular to the optical axis of the viewfinder. Therefore, the resistance to compressive deformation of a connector 808c of the three sides is high, and it becomes difficult for the eyecup accessory 700 to be detached from it. In a case where the three sides are not continuous (connected), the resistance of the compressive deformation of the connector 808c when the flange portion 808a is deformed at each side is low, and the repulsive force is small, so that the eyecup accessory 700 can be easily detached from the eyecup 802.

As illustrated in FIG. 7E, a length Y1 in the vertical direction (Y direction) of the left and right portions of the convex portion 703 of the eyecup accessory 700 is less than half a length Y2 in the vertical direction of the left and right portions of the groove portion 808 of the eyecup 802. As illustrated in FIG. 6A, the taper portions 704 for insertion into the groove portion 808 are provided below the left and right portions of the convex portion 703, so that the convex portion 703 can be easily inserted into the groove portion 808 in a case where the eyecup accessory 700 is attached to the eyecup 802.

A convex amount of the convex portion 705 provided at the lower part of the fixed member 702 of the eyecup accessory 700 is smaller than a convex amount of the convex portion 703. Thereby, the portion that is engaged with the groove portion 808 provided to the elastic member 804 is less likely to come off, and the portion that is engaged with groove portion 809 provided in the rear cover 800, which is made of a non-elastic member, is easy to attach.

In a case where a neck strap (not illustrated) is attached to the digital camera 100, the strap may get in space between the eyecup accessory 700 and the digital camera 100 (portion N in FIG. 7B) below the eyepiece frame 801. At this time, it is expected that eyecup accessory 700 will come off digital camera 100. In this embodiment, due to the engagement between the groove portion 809 and the convex portion 705 at the lower portion, which are made of non-elastic members, the eyecup accessory 700 can be prevented from being detached from the digital camera 100 even if the strap gets caught.

In a case where a waterproof sheet shaped to cover the digital camera 100 is fixed to the fixed members 701 and 702, a rain cover for the digital camera 100 can be fixed to the eyepiece portion and used. The eyecup accessory 700 is not limited to that described in this embodiment, and for example, an optical unit may be attached to the fixed members 701 and 702 to serve as a magnifier or angle finder.

### METHOD OF ATTACHING EYECUP ACCESSORY 700

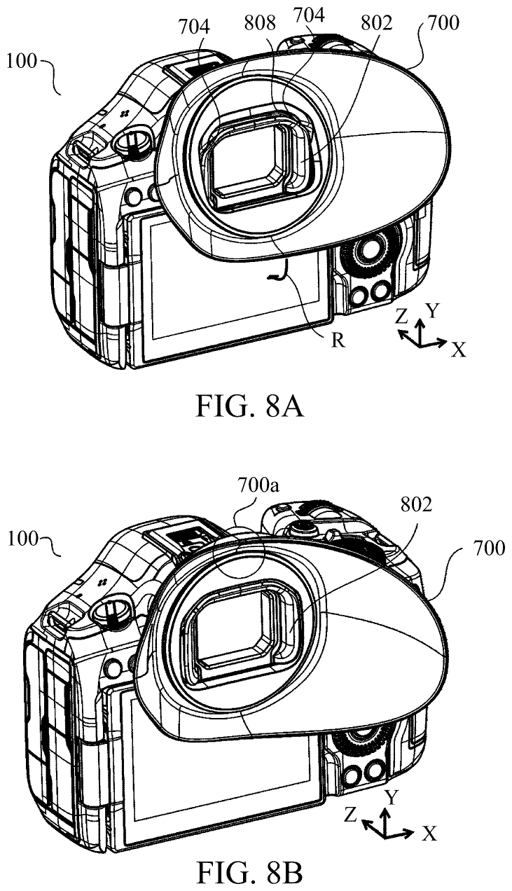

FIGS. 8A and 8B explain the operation in attaching the eyecup accessory 700 to the eyecup 802 fixed to the digital camera 100. FIG. 8A illustrates a state when the eyecup accessory 700 has started to be attached to the eyecup 802. FIG. 8B illustrates a state in a case where the eyecup accessory 700 has been completely attached to the eyecup 802.

The user first tilts the eyecup accessory 700 toward the digital camera 100 so that the X-axis becomes a rotation axis, and inserts the taper portions 704 on the left and right sides into the groove portion 808 of the eyecup 802 from above. In this state, the convex portion 703 is slid downward in the Y direction, and when it hits the contact portion 808b (FIG. 7B) at the back of the groove portion 808, it is pushed in an arrow R direction. Thereby, the convex portion 705 on the lower side of the eyecup accessory 700 is engaged with the groove portion 809 on the lower side of the rear cover 800, and the attachment is completed. At this time, the contact portion 808b elastically deforms in the Y direction, and secures an engagement stroke (engagement amount) for the convex portion 705.

As described above, the eyecup accessory 700 can be easily fixed to the digital camera 100 by inserting the eyecup accessory 700 into the groove portion 808 from above, sliding it in the Y direction, and pushing it in the arrow R direction after it comes into contact.

### METHOD OF DETACHING EYECUP ACCESSORY 700

Next, the operation of detaching the eyecup accessory 700 from the eyecup 802 will be described.

In the state illustrated in FIG. 8B, by pulling the upper portion 700a of the eyecup accessory 700 towards the front in the Z direction, the flange portion 808a of the eyecup 802 is elastically deformed towards the front. Thereby, the convex portion 703 of the eyecup accessory 700 can be disengaged from the groove portion 808 of the eyecup 802 (the groove portion 808 and the convex portion 703 are disengaged). Since the engagement amount of the convex portion 705 is small, it is disengaged from the groove portion 809 at almost the same time that the convex portion 703 is disengaged from the groove portion 808 (the groove portion 809 and the convex portion 705 are disengaged). In this manner, the eyecup accessory 700 can be detached from the eyecup 802 with a simple operation.

As described above, in this embodiment, even when a usual eyecup 802 that is frequently used is fixed to the digital camera 100, the eyecup accessory 700 can be easily attached to the eyecup 802. In addition, due to the large engagement amount of the elastic portion (engagement between the convex portion 703 and the groove portion 808), this engagement is difficult to release. The engagement at the lower portion (engagement between the convex portion 705 and the groove portion 809) where the strap easily gets caught is the engagement between non-elastic members, so that the eyecup accessory 700 is unlikely to come off unintentionally by the user. In a case where the eyecup accessory 700 is to be intentionally detached, the eyecup accessory 700 can be detached from the eyecup 802 by a simple operation of pulling the upper portion 700a of the eyecup accessory 700 to the front.

While the disclosure has described example embodiments, it is to be understood that the disclosure is not limited to the example embodiments. The scope of the following claims is to be accorded the broadest interpretation so as to encompass all such modifications and equivalent structures and functions.

This embodiment can provide an optical apparatus having an eyecup accessory fixing structure that is easy to attach, unlikely to come off unintentionally by the user, and easy to intentionally detach with a simple operation.

This application claims priority to Japanese Patent Application No. 2024-038146, which was filed on Mar. 12, 2024, and which is hereby incorporated by reference herein in its entirety.

What is claimed is:

1. An optical apparatus attachable to and detachable from an accessory, the optical apparatus comprising:
a non-elastic member with an eyepiece frame; and
an eyecup fixed to the eyepiece frame and including an elastic member,
wherein the elastic member includes a first fixing member configured to fix the accessory and provided to at least three outer circumference side surfaces,
wherein the eyepiece frame includes a second fixing member configured to fix the accessory and provided to an area that does not face the at least three outer circumference side surfaces of outer circumference side surfaces, and
wherein the first fixing member and the second fixing member fix the accessory in a case where the accessory is attached to the optical apparatus.

2. The optical apparatus according to claim 1, wherein the accessory includes a first engagement member engageable with the first fixing member and a second engagement member engageable with the second fixing member,
wherein each of the first engagement member and the second engagement member includes a convex portion, and
wherein each of the first fixing member and the second fixing member includes a groove portion.

3. The optical apparatus according to claim 1, wherein when the optical apparatus is viewed from a back at a normal position, the first fixing member is provided at an upper side, a left side, and a right side of the eyepiece frame, and the second fixing member is provided at a lower side of the eyepiece frame.

4. The optical apparatus according to claim 1, wherein the accessory includes a first engagement member engageable with the first fixing member, and a second engagement member engageable with the second fixing member, and
wherein in a case where the accessory is attached to the optical apparatus, the first fixing member and the first engagement member are engaged, and then the second fixing member and the second engagement member are engaged.

5. The optical apparatus according to claim 1, wherein the accessory includes a first engagement member engageable with the first fixing member, and a second engagement member engageable with the second fixing member, and
wherein in a case where the accessory is detached from the optical apparatus, the first fixing member and the first engagement member are disengaged, and then the second fixing member and the second engagement member are disengaged.

6. An accessory attachable to and detachable from an optical apparatus that includes a non-elastic member having an eyepiece frame, and an eyecup including an elastic member and fixed to the eyepiece frame, the accessory comprising:
a first engagement member engageable with a first fixing member provided on at least three outer circumference side surfaces of the elastic member; and
a second engagement member engageable with a second fixing member provided to an area that does not face the at least three outer circumference side surfaces of outer circumference side surfaces of the eyepiece frame.

7. The accessory according to claim 6, wherein each of the first and second fixing member includes a groove portion, and
wherein each of the first engagement member and the second engagement member includes a convex portion.

8. The accessory according to claim 7, wherein the first engagement member has a shape that is continuous in three directions around an outer circumference of the eyecup.

9. The accessory according to claim 6, wherein when the optical apparatus at a normal position is viewed from a back while the accessory is attached to the optical apparatus, in the first fixing member and the first engagement member are provided at positions on an upper side, a left side, and a right side of the eyepiece frame, and
wherein a length of each of a left portion and a right portion of the first engagement member is less than half a length of each of a left portion and a right portion of the first fixing member.

10. The accessory according to claim 6, wherein when the optical apparatus at a normal position is viewed from a back while the accessory is attached to the optical apparatus, the first engagement member is provided at positions on an upper side, a left side, and a right side of the eyepiece frame, and
wherein a taper portion is formed at a lower end of each of a left portion and a right portion of the first engagement member.

11. The accessory according to claim 6, wherein while the accessory is attached to the optical apparatus, an engagement amount of the first engagement member is longer than an engagement amount of the second engagement member.

12. A method for attaching an accessory that is attachable to and detachable from an optical apparatus that includes a non-elastic member with an eyepiece frame, and an eyecup fixed to the eyepiece frame and including an elastic member, the accessory including a first engagement member engageable with a first fixing member provided to at least three outer circumference side surfaces of the elastic member, and a second engagement member engageable with a second fixing member provided to an area that does not face the at least three outer circumference side surfaces of outer circumference side surface of the eyepiece frame, the method comprising:
engaging the first fixing member with the first engagement member; and
engaging the second fixing member with the second engagement member.

13. A method for detaching an accessory that is attachable to and detachable from an optical apparatus that includes a non-elastic member with an eyepiece frame, and an eyecup fixed to the eyepiece frame and including an elastic member, the accessory including a first engagement member engageable with a first fixing member provided to at least three outer circumference side surfaces of the elastic member, and a second engagement member engageable with a second fixing member provided to an area that does not face the at least three outer circumference side surfaces of outer circumference side surface of the eyepiece frame, the method comprising:
disengaging the first fixing member from the first engagement member; and
disengaging the second fixing member from the second engagement member.
